(19) United States
(12) Patent Application Publication
(10) Pub. No.: US 2006/0153108 A1
(43) Pub. Date: Jul. 13, 2006

(54) VoIP terminal capable of facsimile communication and communication method thereof

(75) Inventor: Yutaka Nakajima, Tokyo (JP)

Correspondence Address: MCGINN INTELLECTUAL PROPERTY LAW GROUP, PLLC, 8321 OLD COURTHOUSE ROAD, SUITE 200, VIENNA, VA, 22182-3817, US

(73) Assignee: Allied Telesis Kabushiki Kaigha, Tokyo (JP)

(21) Appl. No.: 10/240,248

(22) Filed: Sep. 30, 2002

(30) Foreign Application Priority Data
Mar. 25, 2002 (WO) PCT/JP02/02833

(51) Int. Cl. H04B 3/20; H04L 12/66

(52) U.S. Cl. 370/286; 370/352

(57) ABSTRACT

A simple VoIP terminal and a communication method thereof which allow facsimile communication by a VoIP terminal unequipped with H.323D facilities. Whether or not a call request from a facsimile/telephone terminal is followed by a CNG signal is determined. If the CNG signal is detected, G.711 CODEC alone is selected from among a plurality of audio CODECs provided in advance to create a CODEC list. A call request is issued to a calling party with the CODEC list included.

### BACKGROUND OF THE INVENTION

1. Field of the Invention

The present invention relates to a system for implementing facsimile communication over a packet network. In particular, the invention relates to a voice over Internet Protocol (VoIP) terminal and a communication method thereof for performing facsimile communication on VoIP which transmits voice over an Internet Protocol (IP) network.

2. Description of the Related Art

With the growth of IP networks, VoIP technology is becoming an important factor in network communications. It is hence to be desired strongly that facsimile communication prevalent in conventional public switched telephone networks (PSTNs) be implemented on VoIP as well. Real-time facsimile communication over an IP network currently requires terminals that support the procedure of ITU-T H.323 Annex D (hereinafter, referred to as H.323D terminals).

According to ITU-T H.323 Annex D, the H.323D terminals, when setting up a channel for transmitting T.38packets, establish a voice-specific logical channel which depends on the capabilities of a calling party and a called party, and a facsimile channel which includes two logical channels for transmitting the T.38 packets (from the called party to the calling party, and vice versa). The H.323D terminals then communicate through the separate lines at respective bands.

Meanwhile, ITU-T H.323 Annex F introduces the concept of a “Simple Endpoint Type” or “SET.” In particular, there are defined SETs for audio communication that are compliant with IP telephony applications of facilities limited by employing H.323 protocol subsets. Hereinafter, SET-compliant terminals unequipped with H.323D facilities, such as those defined in ITU-T H.323 Annex F, will be referred to as H.323F terminals.

H.323F terminals support voice capabilities or CODECs including G.711 (A-law, μ-law, 56 kbit/s, 64 kbit/s), G.723.1, and G.729a (8 kbps). H.323F terminals also differ from H.323D terminals in that only a single channel is established in communication.

As stated above, it is possible at present to implement facsimile communication over an IP network by using H.323D terminals. This facsimile communication, however, can only be effected between terminals that are equipped with the same H.323D facilities, no such cases that an H.323F terminal is on the other end.

Besides, ITU-T H.323 Annex F does no more than suggest the facsimile communication based on H.323F terminals for consideration.

### SUMMARY OF THE INVENTION

In view of the foregoing, it is an object of the present invention to provide a simple VoIP terminal and a communication method thereof for allowing facsimile communication with terminals unequipped with H.323D facilities.

The VoIP terminal according to the present invention modifies an audio capability list to be presented to a called party at the time of a call request, based on the presence or absence of a CNG signal coming from communication equipment, and thereby allows facsimile communication by an H.323F terminal unequipped with H.323D facilities, for example.

According to a first aspect of the present invention, a VoIP terminal capable of communication on VoIP for transmitting voice over an IP network includes: CNG signal detecting means for detecting presence or absence of a CNG signal coming from communication equipment connected; and capability list modifying means for modifying an audio capability list to be presented to a called party at the time of a call request, based on the presence or absence of the CNG signal.

When the CNG signal is not detected, CODEC list creating means may select any one(s) of a plurality of audio CODECs to create an audio CODEC list. The plurality of audio CODECs desirably include at least an essential audio capability. Here, it is desirable that G.711 protocol be included, and that a predetermined CODEC to be selected when the CNG signal is detected is the G.711.

According to a second aspect of the present invention, a communication method of a VoIP terminal capable of communication on VoIP for transmitting voice over an IP network includes the steps of: detecting whether or not a CNG signal is input after a call request from communication equipment connected; and modifying an audio capability list to be presented to a called party at the time of a call request to the called party, based on presence or absence of the CNG signal.

Now, according to a third aspect of the present invention, a computer program for making a computer perform a facsimile communication operation on a packet network is provided. The computer program makes the computer perform the communication operation on VoIP for transmitting voice over an IP network, and includes the steps of: determining whether or not a CNG signal is detected after a call request from a terminal; selecting, when the CNG signal is detected, a predetermined CODEC from among a plurality of audio CODECs provided in advance; and issuing a call request to a called party with the selected predetermined CODEC alone included.

As has been described, according to the present invention, the CODEC list to be notified of by means of a calling message based on the presence or absence of detection of the CNG signal can be modified to open, for example, a voice channel of maximum bandwidth (G.711) supported by an H.323 terminal in the case of facsimile communication. Besides, the H.323 terminal need not be equipped with special protocols or CODECs for facsimile communication.

Since G.711 is a capability essential to H.323F terminals of simple endpoint type, the H.323 terminal of the present invention can make facsimile communication not only with H.323D terminals but with H.323F terminals as well.

In addition, according to the present invention, G.711 channels (64 kbit/s) are used in facsimile communication alone. Ordinary voice calls may use other CODECs (such as G.723 of 6.3 kbps). This allows effective use of the IP network band.

### BRIEF DESCRIPTION OF THE DRAWINGS

These and other objects and advantages of the present invention will become clear from the following description with reference to the accompanying drawings, wherein:

FIG. 1 is a schematic diagram showing a facsimile communication system over an IP network using a VoIP terminal according to the present invention;

FIG. 2 is a schematic internal block diagram of an H.323 terminal which is one of embodiments of the VoIP terminal according to the present invention; and

FIG. 3 is a flowchart showing an embodiment of the communication method of a VoIP terminal according to the present invention.

### DETAILED DESCRIPTION OF THE PREFERRED EMBODIMENT

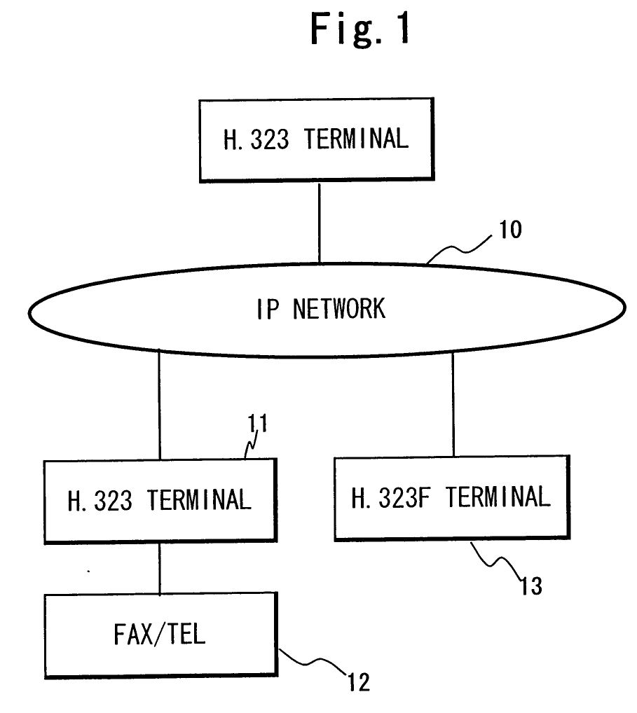

FIG. 1 is a schematic diagram showing a facsimile communication system over an IP network using a facsimile communication apparatus according to the present invention.

An H.323 terminal 11 according to the present invention is connected with a facsimile/telephone terminal (hereinafter, referred to as FAX/TEL terminal) 12. As will be described later, the H.323 terminal 11 adjusts the audio capability (CODEC mode) at the time of channel setup, depending on whether a call from the FAX/TEL terminal 12 is a facsimile communication or a telephone call. This allows facsimile communication with an H.323F terminal having no H.323D facilities.

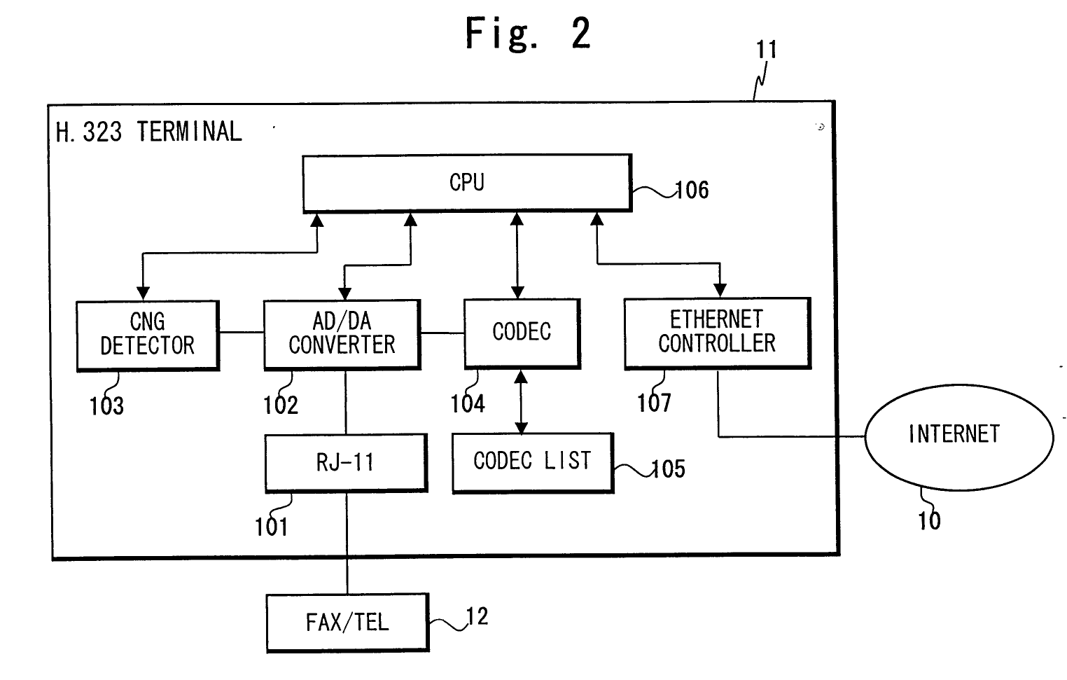

FIG. 2 is a schematic internal block diagram of the H.323 terminal which is an embodiment of the facsimile communication apparatus according to the present invention. The FAX/TEL terminal 12 is connected to the H.323 terminal 11 through an RJ-11 connector 101.

The H.323 terminal 11 has an analog-to-digital/digital-to-analog (AD/DA) converter 102 which is connected to the RJ-11 connector 101. The AD/DA converter 102 is connected with a CNG detector 103 for detecting a CNG signal in facsimile communication, and a CODEC 104. On detecting the CNG signal, the CNG detector 103 outputs a CNG detection signal to a CPU 106 to notify that the CNG signal is detected.

The CODEC 104 is provided in advance with such audio CODECs as G.723 (6.3 kbps), aside from G.711 (64 kbps) which is an essential audio capability. A list thereof is stored in a CODEC list 105. By using CODECs selected under the instructions of the CPU 106, the CODEC 104 encodes signals coming from the FAX/TEL terminal 12 or decodes encoded signals received from the other end of connection.

The CPU 106 is a program-controlled processor which runs programs stored in a memory (not shown) to control standard operations and facsimile communication operations of the H.323 terminal 11. For example, when the CNG signal is detected by the CNG detector 103 as will be described later, the CPU 106 selects the G.711 CODEC and issues a call request to the other end. The CPU 106 is connected to an Ethernet controller 107. The Ethernet controller 107 establishes connection with an IP network 10 such as the Internet.

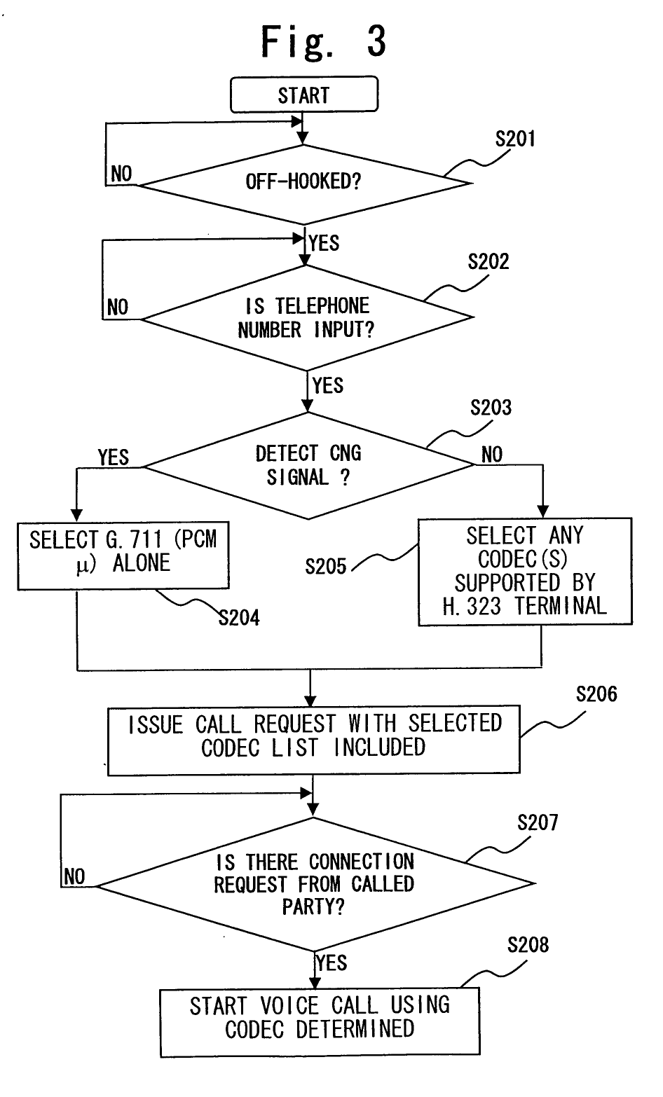

FIG. 3 is a flowchart showing an embodiment of a facsimile communication method according to the present invention.

Initially, the FAX/TEL terminal 12 is off-hooked (YES at step S201). The telephone number of a party to be called is input (YES at step S202), and the CPU 106 determines if the CNG signal is detected subsequently (step S203). When the FAX/TEL terminal 12 is making a facsimile communication, the call request is followed by the CNG signal. Thus, when the CNG detection signal is received from the CNG detector 103, the call is determined to be a facsimile communication.

When the CNG signal is detected (YES at step S203), the CPU 106 selects G.711 (here, μ-law, 64 kbit/s) alone and creates a CODEC list for capability exchange (step S204).

On the other hand, if the CNG signal is not detected (NO at step S203), the call is determined to be an ordinary voice call. Then, through a normal capability exchange procedure, the CPU 106 selects any CODEC(s) specified by the user from among those supported by the H.323 terminal and creates a CODEC list (step S205).

Subsequently, the CPU 106 includes the CODEC list created at step S204 or S205 into a call request and transmits the call request including the CODEC list to the called party (step S206). If the called party responds with a connection request (YES at step S207), the communication is started using a CODEC determined by the capability exchange.

Specifically, when the CNG signal is detected, a high-bit-rate facsimile communication is performed using G.711 (μ-law, 64 kbit/s). When the CNG signal is not detected, a voice call is made using, e.g., G.723 (6.3 kbps). In the case of facsimile communication, a channel of 64 k bit rate is thus established for communication.

A computer program including the foregoing steps S201 to S208 may be stored in a memory so that the program can be read and executed by the CPU 106 to implement the facsimile communication method of the present invention.

While there has been described what are at present considered to be preferred embodiments of the invention, it will be understood that various modifications may be made thereto, and it is intended that the appended claims cover all such modification as fall within the true spirit and scope of the invention.

What is claimed is:

1. A voice over Internet Protocol (VoIP) terminal capable of communication on VoIP for transmitting voice over an Internet Protocol (IP) network, comprising:
a CNG signal detector for detecting a CNG signal coming from communication equipment connected to the VoIP terminal; and
a capability list modifier for modifying an audio capability list to be presented to a called party when making a call request, depending on whether the CNG signal is detected.

2. A voice over Internet Protocol (VoIP) terminal capable of communication on VoIP for transmitting voice over an Internet Protocol (IP) network, comprising:
a connector for connecting communication equipment to the VoIP terminal;
a plurality of audio CODECs provided in advance;
a CNG signal detector for detecting a CNG signal coming from said communication equipment;
a CODEC list creator for creating an audio CODEC list by selecting a predetermined CODEC from among said plurality of audio CODECs when said CNG signal is detected; and
a calling device for issuing a call request including said audio CODEC list.

3. The VoIP terminal according to claim 2, wherein, when said CNG signal is not detected, said CODEC list creator arbitrarily selects at least one of said plurality of audio CODECs to create said audio CODEC list.

4. The VoIP terminal according to claim 2, wherein said plurality of audio CODECs include at least G.711 protocol, and said predetermined CODEC to be selected when said CNG signal is detected is the G.711 protocol.

5. The VoIP terminal according to claim 3, wherein said plurality of audio CODECs include at least G.711 protocol, and said predetermined CODEC to be selected when said CNG signal is detected is the G.711 protocol.

6. A communication method of a voice over Internet Protocol (VoIP) terminal capable of communication on VoIP for transmitting voice over an Internet Protocol (IP) network, comprising the steps of:
determining whether a CNG signal is received after a call request has been received from communication equipment connected to the VoIP terminal; and
modifying an audio capability list to be presented to a called party when making a call request to said called party, depending on whether said CNG signal is received.

7. A communication method of a voice over Internet Protocol (VoIP) terminal capable of communication on VoIP for transmitting voice over an Internet Protocol (IP) network, comprising the steps of:
preparing a plurality of audio CODECs in advance;
determining whether a CNG signal is detected after a call request from communication equipment connected to the VoIP terminal;
selecting a predetermined CODEC from among said plurality of audio CODECs when said CNG signal is detected; and
issuing a call request to a called party with including said selected predetermined CODEC alone.

8. The communication method according to claim 7, wherein, when said CNG signal is not detected, at least one of said plurality of audio CODECs is arbitrarily selected and a call request is issued to said called party with including said at least one audio CODEC selected.

9. The communication method according to claim 7, wherein said plurality of audio CODECs include at least G.711 protocol, and said predetermined CODEC to be selected when said CNG signal is detected is the G.711 protocol.

10. The communication method according to claim 8, wherein said plurality of audio CODECs include at least G.711 protocol, and said predetermined CODEC to be selected when said CNG signal is detected is the G.711 protocol.

11. A computer program for a voice over Internet Protocol (VoIP) terminal for making a computer perform a communication operation on VoIP for transmitting voice over an Internet Protocol (IP) network, comprising the steps of:
determining whether a CNG signal is detected after a call request from communication equipment connected to the VoIP terminal;
selecting a predetermined CODEC from among a plurality of audio CODECs when said CNG signal is detected; and
issuing a call request to a called party with including said selected predetermined CODEC alone.

12. The computer program according to claim 11, wherein, when said CNG signal is not detected, at least one of said plurality of audio CODECs is arbitrarily selected and a call request is issued to said called party with including said at least one audio CODEC selected.

13. The computer program according to claim 11, wherein said plurality of audio CODECs include at least G.711 protocol, and said predetermined CODEC to be selected when said CNG signal is detected is the G.711 protocol.

14. The computer program according to claim 12, wherein said plurality of audio CODECs include at least G.711 protocol, and said predetermined CODEC to be selected when said CNG signal is detected is the G.711 protocol.
